(19) United States
(12) Patent Application Publication
(10) Pub. No.: US 2014/0227670 A1
(43) Pub. Date: Aug. 14, 2014

(54) SYSTEMS AND METHODS FOR PROBABILISTICALLY GENERATING INDIVIDUALLY CUSTOMIZED COGNITIVE TRAINING SESSIONS

(71) Applicant: Lumos Labs, Inc., San Francisco, CA (US)

(72) Inventors: Daniel A. STERNBERG, San Francisco, CA (US); Kacey Ballard CORRADO, San Francisco, CA (US)

(73) Assignee: Lumos Labs, Inc., San Francisco, CA (US)

(21) Appl. No.: 14/178,610

(22) Filed: Feb. 12, 2014

Related U.S. Application Data
(60) Provisional application No. 61/764,695, filed on Feb. 14, 2013.

(51) Int. Cl. G09B 23/28

(52) U.S. Cl. CPC G09B 23/28
USPC 434/236

(57) ABSTRACT

A method, computing device, and non-transitory computer readable storage medium are disclosed for probabilistically generating individually customized cognitive training sessions. A probability calculator executing on a computing device determines user data, priorities, and game data. The probability calculator calculates initial probabilities that a neurocognitive game will appear in a session, where the session includes neurocognitive games selected for presentation to a user (e.g., on a specific day), the calculating based on the user data, the priorities, and the game data. The probability calculator communicates, to a game selector, the initial probabilities, the game data, and a matrix controlling how likely neurocognitive games will appear in the session. The game selector selects a set of neurocognitive games for the session, where the selecting is based on the initial probabilities, the game data, and the matrix.

### CROSS-REFERENCE

This application claims the benefit of U.S. Provisional Application No. 61/764,695, filed Feb. 14, 2013, for Systems and Methods for Probabilistically Generating Individually Customized Cognitive Training Sessions by Sternberg et al. which application is incorporated herein by reference.

### BACKGROUND OF THE INVENTION

Cognitive training is an effective way of enhancing mental abilities in humans. Dozens of articles have been written in peer-reviewed journals describing the benefits of cognitive training The possible benefits of cognitive training may include improving cognitive skills that contribute to many real-world abilities, such as driving, performing well in school, and carrying out other activities of daily living.

Individuals wishing to improve their cognitive abilities face numerous challenges in achieving their goals, however. It remains inherently difficult for users to determine which cognitive training exercises are useful given their desired benefits. Different cognitive training exercises target different abilities, and it may be challenging for an individual to connect these abilities, such as working memory, to a real-world goal, such as doing better in school. Additionally, users may not know how much and how often they need to train with a particular exercise in order to benefit.

### SUMMARY OF THE INVENTION

There remains a need to dynamically customize a cognitive training regimen to efficiently train users based on their specified goals and preferences. Thus, what is needed are systems and methods for probabilistically generating individually customized cognitive training sessions.

In one aspect, a method, computing device, and non-transitory computer readable storage medium are disclosed for probabilistically generating individually customized cognitive training sessions. A probability calculator executing on a computing device determines user data, priorities, and game data. User data, priorities, and game data can also be provided to the probability calculator, which can then use that additional information to determine initial probabilities. The probability calculator calculates initial probabilities that a neurocognitive game will appear in a session, where the session includes neurocognitive games selected for presentation to a user (e.g., on a specific day), the calculating based on the user data, the priorities, and the game data. The probability calculator communicates, to a game selector, the initial probabilities, the game data, and a matrix controlling how likely neurocognitive games will appear together in the session. The game selector selects a set of neurocognitive games for the session, where the selecting is based on the initial probabilities, the game data, and the matrix.

In one embodiment, the determining of the priorities includes one or more of determining priorities derived from the user's play history and information about each neurocognitive game in the games selected for presentation to the user, determining popularity of the neurocognitive game, determining how a neurocognitive game relates to a ranking associated with the user of neurocognitive domains, determining measures of previous performance on the neurocognitive game by the user, and/or determining measures of previous performance in a neurocognitive domain with which the game is associated.

A weighting factor may also be associated with each priority. Further, deviations from expected frequencies may be controlled by the probability calculator. Initial probabilities may be adjusted for local consistency. For example, local consistency can equal training consistently on a given neurocognitive game over a small number of sessions. The calculating of the initial probabilities can include, for a priority, determining:

$${γ}_{i} = \frac{{X}_{i} - μ}{σ}$$

where xᵢ is a raw score for a game, μ is an arithmetic mean of the raw score for the games in the game set, and σ is a standard deviation of the raw score for the games in the game set.

In another aspect, a method, computing device, and non-transitory computer readable storage medium include (a) receiving, by a game selector executing on the computing device, game data with game probabilities and a game matrix, (b) determining, by the game selector, whether there are novel games to be introduced in a session, (c) if there are novel games to be introduced, selecting, by the game selector, a game with a lowest session introduction number, (d) if there are no novel games to be introduced, selecting, by the game selector, a game with a predetermined probability, (e) adjusting, by the game selector, probabilities via the game matrix (e.g., a row of the game matrix), and (f) repeating, by the game selector, steps (b)-(e) until a predetermined number of games have been selected.

In one embodiment, one or more of the predetermined number of games are presented to the user in the session. The determining of whether there are novel games to be introduced in a session can include determining if a current session number of the game is greater than or equal to the session introduction number of the game and a play count for the game is equal to a predetermined play count number (e.g., zero). The game selector can also adjust probabilities for a predetermined duration.

### INCORPORATION BY REFERENCE

All publications, patents, and patent applications mentioned in this specification are herein incorporated by reference to the same extent as if each individual publication, patent, or patent application was specifically and individually indicated to be incorporated by reference. Patents and publications of interest to the field include, for example, U.S. Pat. No. 7,773,097 for Visual Emphasis for Cognitive Training Exercises; and U.S. Pat. No. 7,540,615 for Cognitive Training Using Guided Eye Movements.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A is a block diagram showing a representative example of a logic device through which targeting specific benefits with cognitive training can be achieved;

FIG. 1B is a block diagram of an exemplary computing environment through which targeting specific benefits with cognitive training can be achieved;

FIG. 1C is an illustrative architectural diagram showing some structure that can be employed by devices through which targeting specific benefits with cognitive training is achieved;

FIG. 2 is a block diagram showing the cooperation of exemplary components of a system suitable for use in a system where targeting specific benefits with cognitive training is achieved;

FIG. 3A is a screenshot that illustrates an exemplar personalized introductory page according to the disclosure;

FIG. 3B is a screenshot that illustrates an exemplar personalized survey page according to the disclosure;

FIG. 3C is a screenshot that illustrates an exemplar neurocognitive domain priority ordering according to the disclosure;

FIGS. 4A-D are screenshots that illustrates alternative screens for the system;

FIG. 5 is a flow diagram of an example of a game selection process according to the disclosure;

FIG. 6 is a flow diagram of exemplary inputs to and outputs from a probability calculator according to the disclosure; and

FIG. 7 is a flow diagram of an exemplar game selector according to the disclosure.

### DETAILED DESCRIPTION OF THE INVENTION

### I. Computing Systems

The systems and methods described herein rely on a variety of computer systems, networks and/or digital devices for operation. In order to fully appreciate how the system operates, an understanding of suitable computing systems is useful. The systems and methods disclosed herein are enabled as a result of application via a suitable computing system.

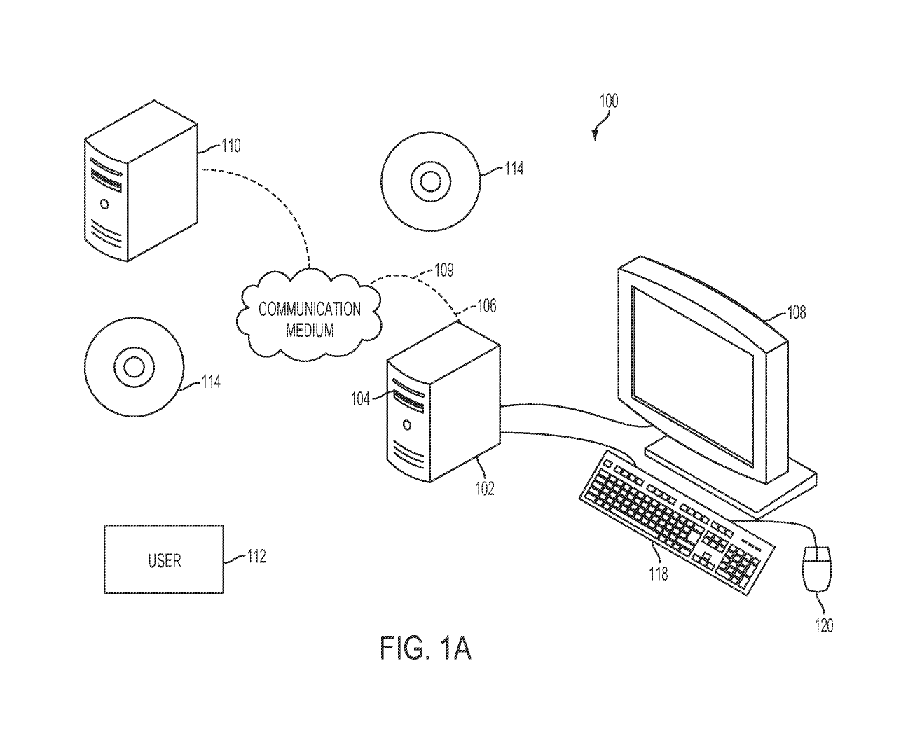

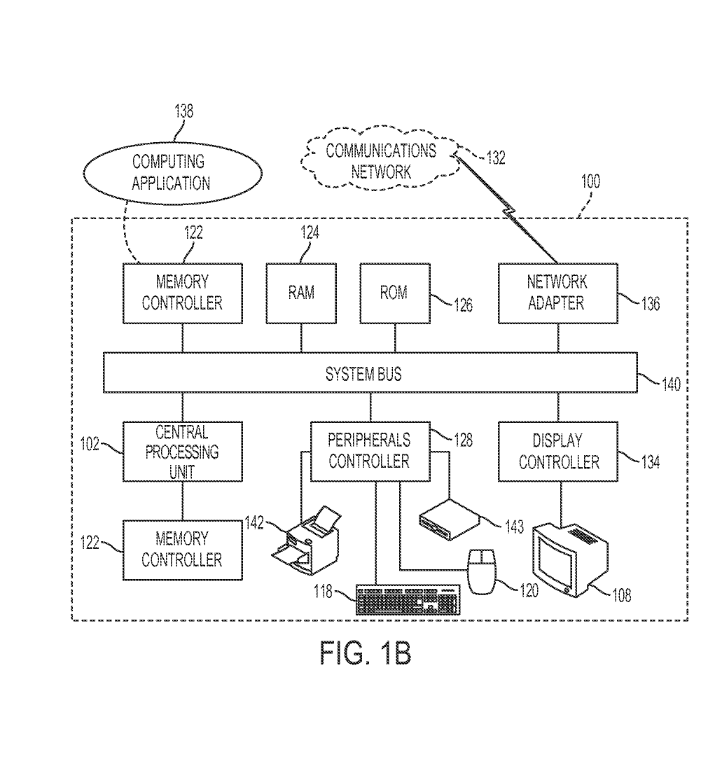

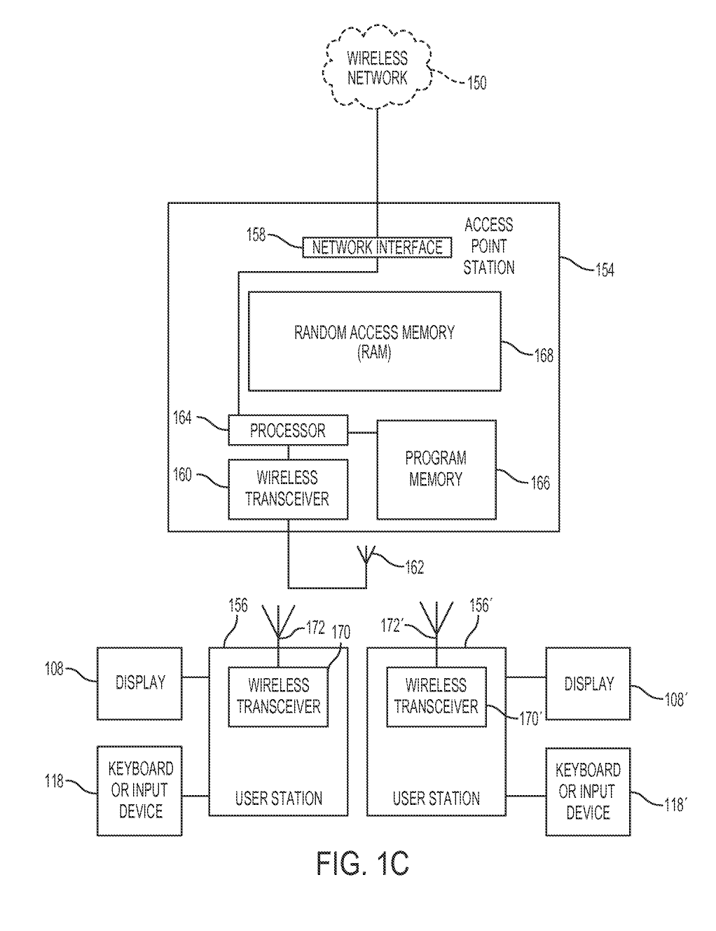

FIG. 1A is a block diagram showing a representative example logic device through which a browser can be accessed to implement the present invention. A computer system (or digital device) 100, which may be understood as a logic apparatus adapted and configured to read instructions from media 114 and/or network port 106, is connectable to a server 110, and has a fixed media. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present disclosure can be transmitted over such networks or connections. The computer system can be capable of, or in at least some situations adaptable for, communicating with a participant and/or a device used by a participant. The computer system is adaptable to communicate with other computers over the Internet, or with computers via a server.

FIG. 1B depicts another exemplary computing system 100. The computing system 100 is capable of, or in at least some situations adaptable for, executing a variety of computing applications 138, including computing applications, a computing applet, a computing program, or other instructions for operating on computing system 100 to perform at least one function, operation, and/or procedure. Computing system 100 is controllable by computer readable storage media for tangibly storing computer readable instructions, which may be in the form of software. The computer readable storage media capable of, or in at least some situations adaptable to, tangibly store computer readable instructions can contain instructions for computing system 100 for storing and accessing the computer readable storage media to read the instructions stored thereon themselves. Such software may be executed within CPU 102 to cause the computing system 100 to perform desired functions. In many known computer servers, workstations and personal computers, CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 134, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a tablet, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

### III. Wireless Networks

Wireless networks can incorporate a variety of types of mobile devices, such as, e.g., cellular and wireless telephones, tablets, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

FIG. 1C depicts components that can be employed in system configurations enabling the systems and technical effect of this disclosure, including wireless access points to which client devices communicate. In this regard, FIG. 1C shows a wireless network 150 connected to a wireless local area network (WLAN) 152. The WLAN 152 includes an access point (AP) 154 and a number of user stations 156, 156′. For example, the network 150 can include the Internet or a corporate data processing network. The access point 154 can be a wireless router, and the user stations 156, 156′ can be portable computers, personal desk-top computers, tablets, smartphones, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172′ for communication to the access point 154. By way of example, in some embodiments an authenticator could be employed within such an access point (AP) and/or a supplicant or peer could be employed within a mobile node or user station. Display 108, 108′ and keyboard 118, 118′ or input devices can also be provided with the user stations 156, 156′.

### IV. Access Via Browser or “App”

In at least some configurations, a user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones, tablets or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application capable of or adaptable to allowing access to web pages on the World Wide Web. The browser can also include a player (e.g., F1ash™ from Adobe Systems, Inc.), or any other player adapted for the file formats used in the hosting website.

Alternatively, a user executes an application (e.g., “APP” or “mobile APP”) on a device that can connect to a server via a network, which is typically the Internet, but can also be any network, including but not limited to any combination of a LAN, a MAN, a WAN, a mobile, wired or wireless network, a private network, or a virtual private network.

### V. Computer Network Environment

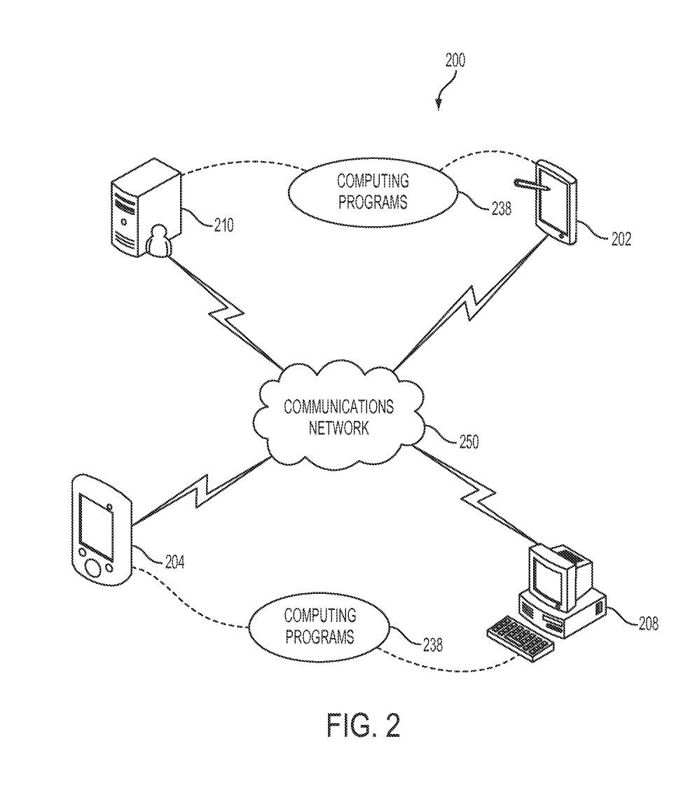

Computing system 100, described above, can be deployed as part of a computer network used to achieve the desired technical effect and transformation. In general, the above description for computing environments applies to both server computers and client computers deployed in a network environment. FIG. 2 illustrates an exemplary illustrative networked computing environment 200, with a server in communication with client computers via a communications network 250. As shown in FIG. 2, server 210 may be interconnected via a communications network 250 (which may be either of, or a combination of a fixed-wire or wireless LAN, WAN, intranet, extranet, peer-to-peer network, virtual private network, the Internet, or other communications network) with a number of client computing environments such as tablet personal computer 202, smart phone 204, personal computer 208, and personal digital assistant. In a network environment in which the communications network 250 is the Internet, for example, server 210 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 200 can utilize various data security protocols such as secured socket layer (SSL) or pretty good privacy (PGP). Each client computing environment can be equipped with operating system 238 operable to support one or more computing applications, such as a web browser (not shown), or other graphical user interface (not shown), or a mobile desktop environment (not shown) to gain access to server computing environment 200.

In operation, a user (not shown) may interact with a computing application running on a client computing environment to obtain desired data and/or computing applications. The data and/or computing applications may be stored on server computing environment 200 and communicated to cooperating users through client computing environments over exemplary communications network 250. The computing applications, described in more detail below, are used to achieve the desired technical effect and transformation set forth. A participating user may request access to specific data and applications housed in whole or in part on server computing environment 200. These data may be communicated between client computing environments and server computing environments for processing and storage. Server computing environment 200 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### VII. Software Programs Implement in the Computing and Network Environments to Achieve a Desired Technical Effect or Transformation

The methods and systems disclosed herein describe how to (1) construct a cognitive training program that includes exercises targeted to produce training outcomes important to individual users, and (2) adapt the program over time to conform to each user's changing skill levels, preferences and desired benefits. In addition, the method ensures the most highly engaging exercises are presented often, to encourage training compliance and enhance the efficacy of the training Computing devices can be provided that are configurable to cause the computing device to perform methods disclosed herein.

The exercises are based on the principals of neuroplasticity. These activities target different neurocognitive domains, including attention, working memory, speed of processing, cognitive flexibility, and problem solving. The exercises are intensive and adaptively challenging, and are designed to enhance cognitive ability at the level of underlying neurocognitive mechanisms. A list of exemplary exercises and some of the neurocognitive domains that they target is included in TABLE 1.

TABLE 1
EXERCISES AND CORRESPONDING
NEUROCOGNITIVE DOMAINS

```
  1. Word Bubbles Rising - Flexibility
  2. Eagle Eye - Attention
  3. Raindrops - Problem Solving
  4. Memory Matrix - Memory
  5. Lost in Migration - Attention
  6. Familiar Faces - Memory
  7. Speed Match - Processing Speed
  8. Brain Shift - Flexibility
  9. Chalkboard Challenge - Problem Solving
10. Penguin Pursuit - Processing Speed
11. Color Match - Flexibility
12. Bird watching - Attention
13. Memory Match - Memory
14. Word Bubbles - Flexibility
15. Word Sort - Problem Solving
16. Observation Tower - Attention
17. Spatial Speed Match - Processing Speed
18. Space Junk - Attention
19. Disillusion - Flexibility
20. Route to Sprout - Flexibility
21. Playing Koi - Attention
22. By the Rules - Problem Solving
23. Disconnection - Flexibility
24. Monster Garden - Memory
25. Top Chimp - Attention
26. Name Tag - Memory
27. Rhyme Workout - Memory
28. Face Memory Workout - Memory
29. Money comb - Memory
30. Memory Match Overload - Memory
31. Brain Shift Overdrive - Flexibility
32. Rotation Matrix - Processing Speed
33. Addition Storm - Problem Solving
34. Subtraction Storm - Problem Solving
35. Division Storm - Problem Solving
36. Multiplication Storm - Problem Solving
37. Memory Lane - Memory
38. Pinball Recall - Memory
39. Follow That Frog - Memory
```

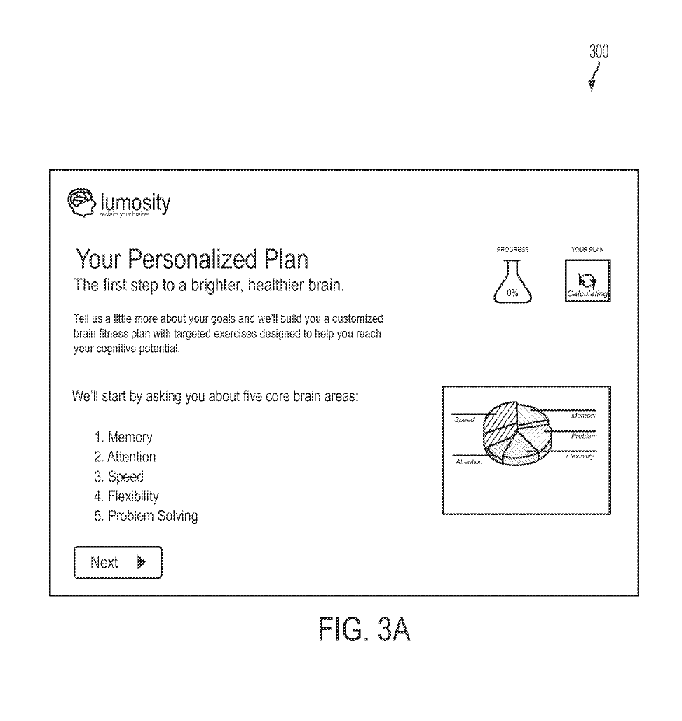

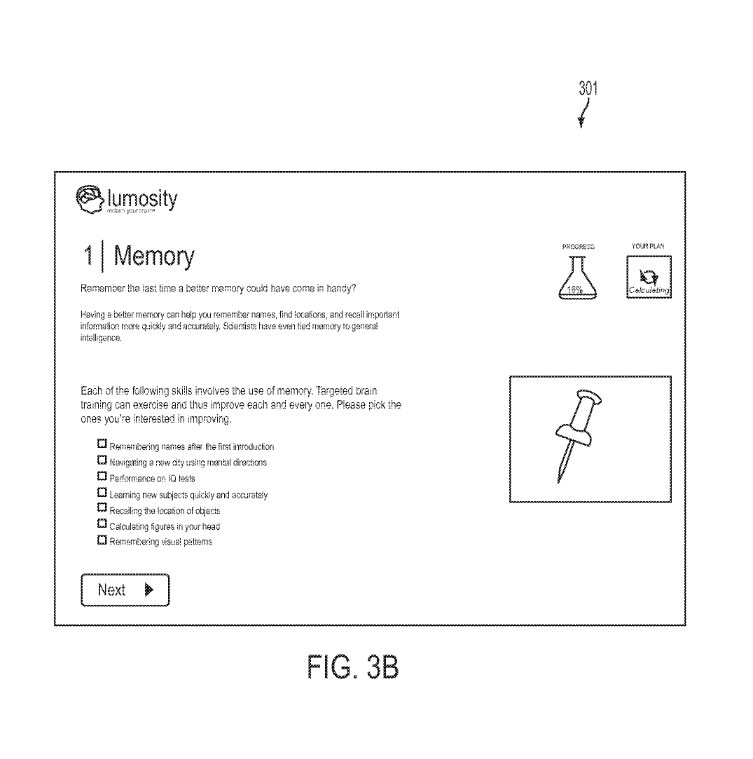

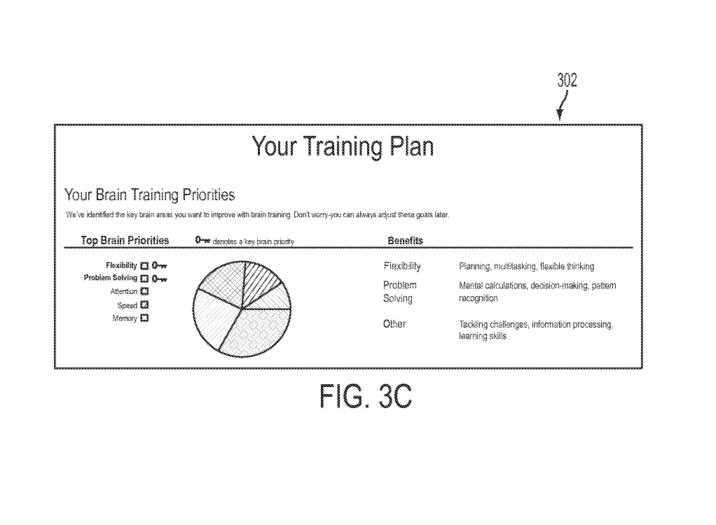

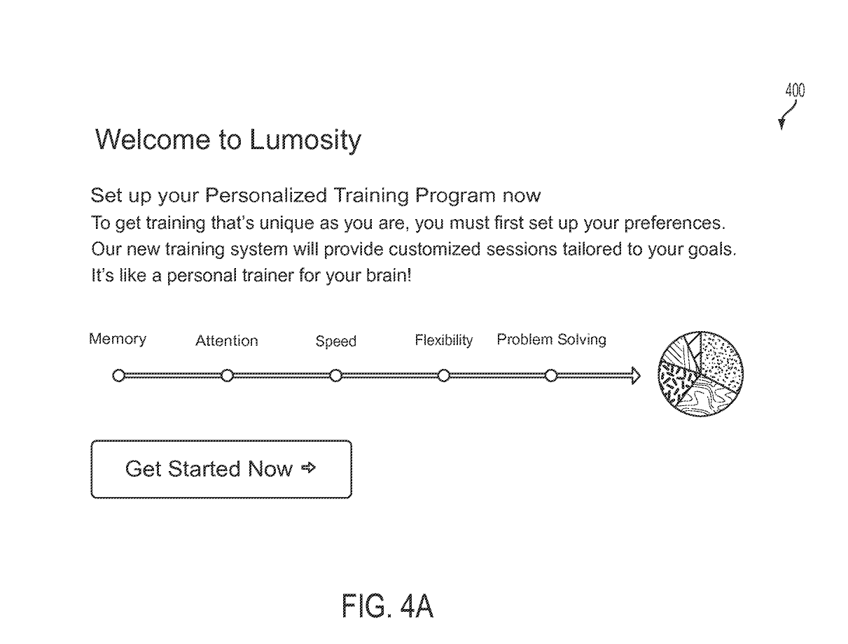

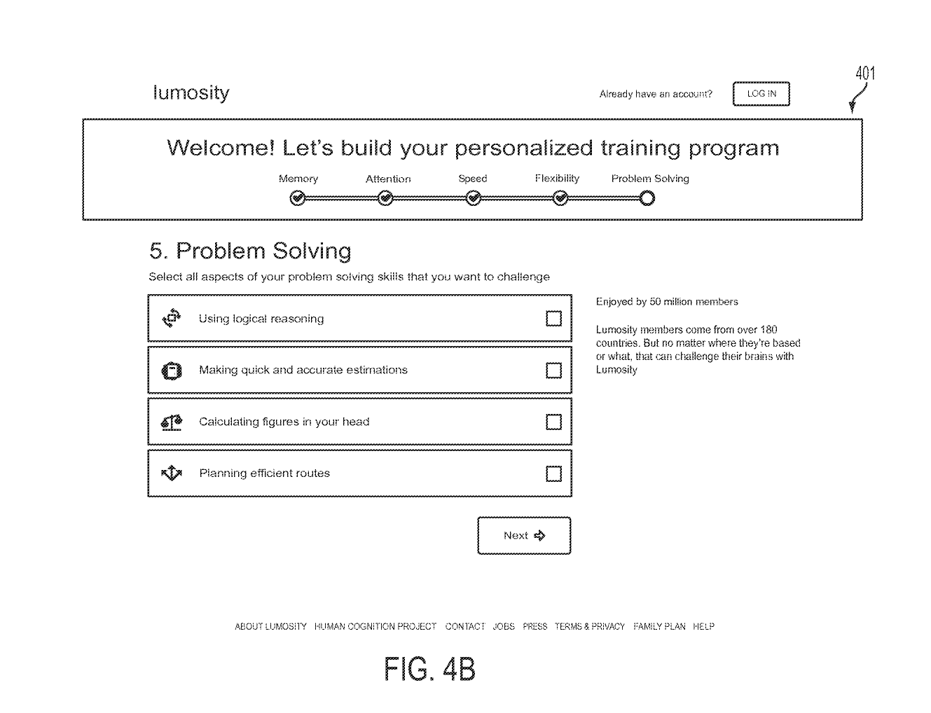

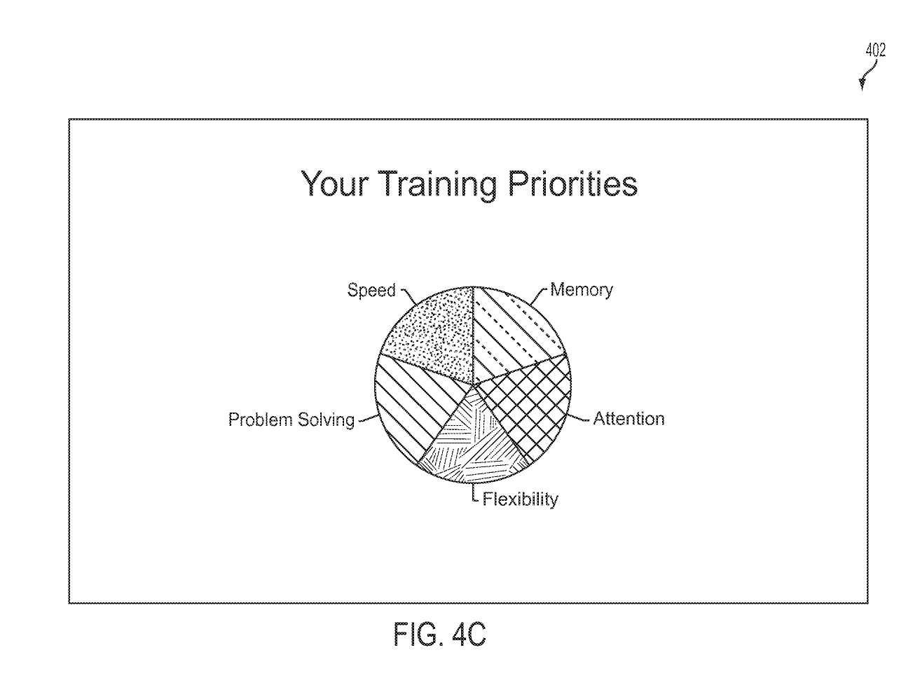

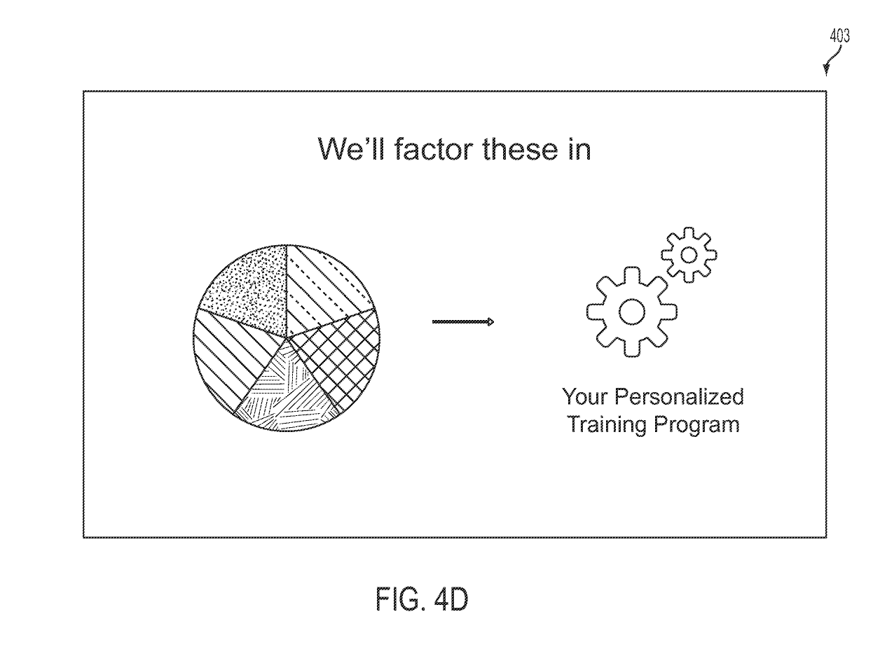

The method works in a series of steps beginning with, for example, a selection of training preferences during a personalization process. The methods and systems include a personalization algorithm through which users select benefits (for example, better remembering of names) or particular cognitive tasks (for example, dividing attention between multiple tasks) that are then linked to specific neurocognitive domains and associated exercises. Users select a number of tasks and/or life benefits from a survey of many possible options (shown as exemplary user interface screens 300, 301 and 302 in FIGS. 3A-C and user interface screens 400, 401, 402 and 403 in FIGS. 4A-D). Each of these options is then linked or linkable to one of several neurocognitive domains, e.g. attention or speed of processing (TABLE 1). In turn, each exercise is linked or linkable to one or more of these domains. Users can also provide biographic data such as, for example, age, education, and gender at this time. Other pieces of user specific biographic data can be provided without departing from the scope of the disclosure. User input is then stored in a database.

When the user has made a selection of target options that are important to them, they submit their choices to create their training priorities. Each user's training priorities consist of a ranked order of neurocognitive domains in accordance with the number of options they selected during the personalization survey for each neurocognitive domain. Based on this ranked order, each domain is given a value from 1-5.

For example, if 6 selections were associated with Processing Speed, 5 were associated with Problem Solving, 4 were associated with Memory, 2 with Attention, and none with Flexibility, the values given to each domain could be set out as follows:

5 points=Processing Speed

4 points=Problem Solving

3 points=Memory

2 points=Attention

1 point=Flexibility

In the case of a tie a tiebreaker ranking could be used so that each neurocognitive domain has a different value. The tiebreaker ranking, in order of highest ranked to lowest, could be as follows:

Memory, Attention, Flexibility, Problem Solving, Processing Speed.

This exemplar ranking has been chosen as an optimal ranking based on a review of stated preference of the five domains in a survey of users. Other rank orders can be chosen without departing from the scope of the disclosure.

In the case of a tie in the number chosen for two different domains, the domain with the highest rank in the aforementioned list is given the greater number of points. These training priorities are stored in a database and are one component used in creating each user's individual training program.

In addition to the rankings, additional user data can also be collected later, such as individual user preferences about specific games determined by, for example, explicit user ratings of games or user behavior in choosing to play certain games or choosing to skip games. Moreover, information about the user's state or context can be collected, including for example, the time the user has to train on that day, the user's mood, amount of sleep, or activity level. In addition, user's past game and training performance, including game scores, results from other assessments, or other measures of cognitive performance can be used.

A. Creating Training Sessions Via the Game Selection Process

A set of games is selected for a particular “training type”, e.g., “Standard”, “Student”, or “Advanced”. For example, “Student” is configurable to include exercises that are more appropriate for younger individuals, “Advanced” is configurable to include some of the most challenging exercises available, and “Standard” is configurable to include a balanced mix. Each of these training types has associated with it information about each game (Game Data). This information could include a popularity rating and a session introduction number, which in one embodiment are chosen by an administrator, and the average duration of the game (which can be estimated or taken from pre-existing gameplay data).

Example table of game data for a “Standard” Training Type:

| | | Session | |
|---|---|---|---|
| | Popularity | Introduction | Average |
| Game | Rating | Number | Duration |
| Birdwatching | 6 | 8 | 4.82 |
| Brain Shift | 4 | 16 | 0.84 |
| By the Rules | 1 | 12 | 3.93 |
| Chalkboard Challenge | 8 | 0 | 3.20 |
| Color Match | 8 | 0 | 0.85 |
| Disconnection | 4 | 4 | 0.81 |
| Disillusion | 7 | 2 | 0.84 |
| Eagle Eye | 10 | 0 | 0.84 |
| Face Memory Workout | 6 | 3 | 1.57 |
| Familiar Faces | 6 | 10 | 3.27 |
| Lost in Migration | 2 | 19 | 6.84 |
| Memory Match | 1 | 21 | 1.89 |
| Memory Matrix | 7 | 6 | 5.73 |
| Monster Garden | 4 | 9 | 2.62 |
| Name Tag | 8 | 0 | 3.12 |
| Observation Tower | 9 | 0 | 1.10 |
| Penguin Pursuit | 4 | 11 | 3.66 |
| Pinball Recall | 9 | 1 | 4.22 |
| Playing Koi | 1 | 22 | 1.26 |
| Raindrops | 9 | 5 | 2.99 |
| Rhyme Workout | 5 | 13 | 2.58 |
| Route to Sprout | 5 | 15 | 5.00 |
| Space Junk | 3 | 20 | 1.58 |
| Spatial Speed Match | 3 | 14 | 3.61 |
| Speed Match | 2 | 17 | 1.33 |
| Top Chimp | 10 | 0 | 4.34 |
| Word Bubbles | 10 | 0 | 2.59 |
| Word Bubbles Rising | 5 | 18 | 2.60 |
| Word Sort | 7 | 7 | 4.49 |

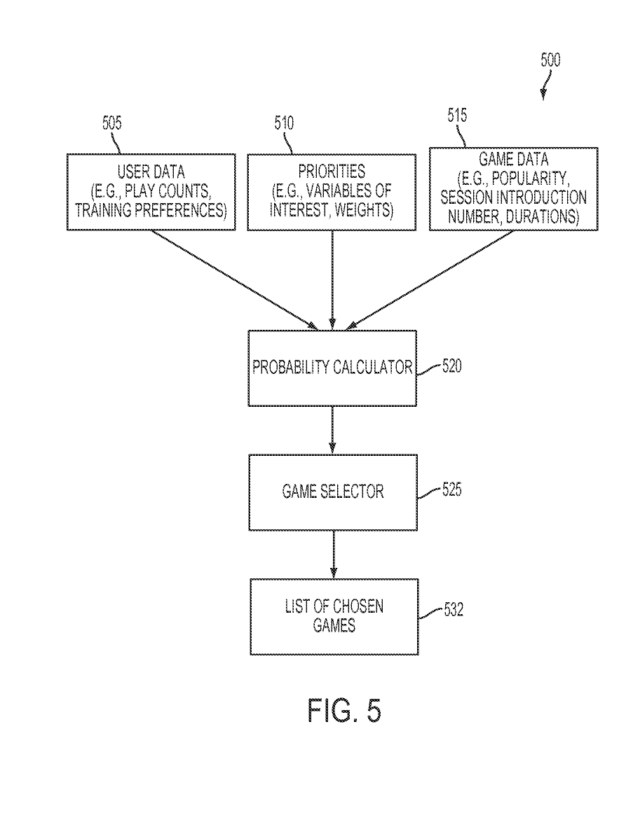

A session consists of a set of games selected to present to the user in a predetermined set of time (e.g., on a given day). The game selection process for a given session makes use of the information described above. FIG. 5 shows a flow diagram of an embodiment of a game selection process 500. The game selection process 500 utilizes different parameters to select a game. These parameters can include, for example, user data 505 (e.g., play counts, training preferences, past game performance), priorities 510 (e.g., variables of interest, weights), and/or game data 515 (e.g., popularity, session introduction number, durations). The parameters 505, 510, 515 are transmitted to a probability calculator 520.

The probability calculator 520 calculates one or more initial probabilities that a game will appear in that session. After the probability calculator 520 has calculated the initial probabilities, these probabilities are given as input to a game selector 525. In one embodiment, the probability calculator 520 also provides game data and a matrix controlling how likely it should be that two games appear together in the same session. The game selector 525 then selects a set of N games, updating the game selection probabilities in the process. The game selector 525 outputs the list of chosen games 532.

B. Probability Calculator

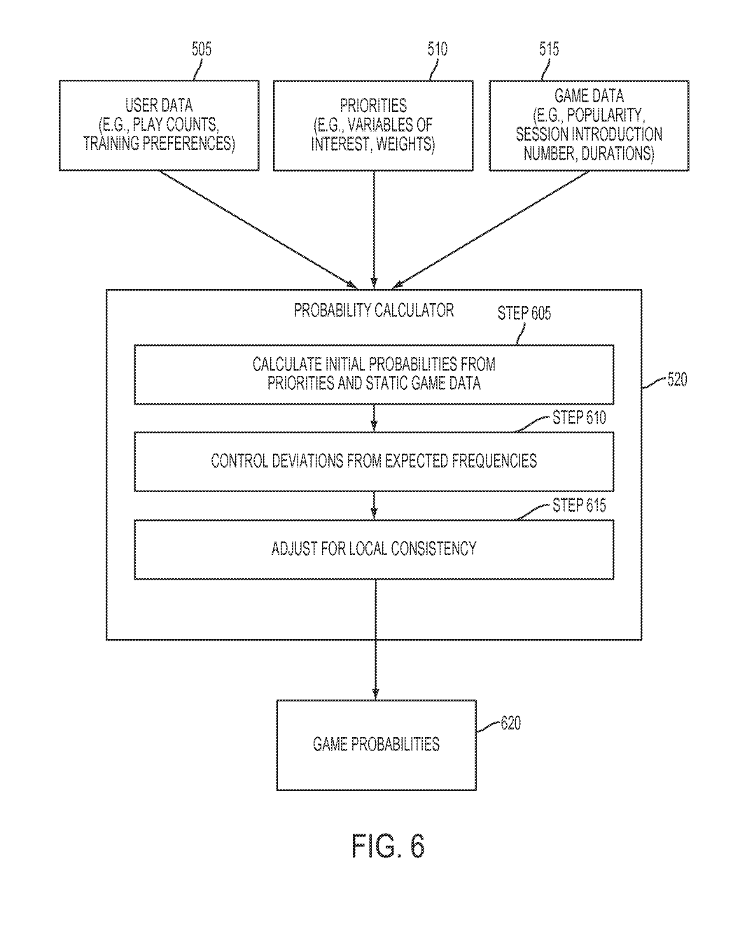

FIG. 6 shows a flow diagram of the inputs to and outputs from the probability calculator 520. The probability calculator 520 can make use of user data 505, game data 515, and priorities 510 to calculate a probability (Step 605) that a given game should be chosen by the game selector 525 FIG. 5). The priorities are the set of variables from user data and game data that are used by the probability calculator along with their weightings to calculate the initial probabilities for each game. These priorities can include variables such the overall popularity of the game (on a rating scale), and how the game relates to particular user's ranking of neurocognitive domains, as derived above.

The priorities could also include other factors, such as measures of the user's previous performance on that game, or measures of the user's previous performance in the neurocognitive domain with which the game is associated. Each game is given a score on these priorities, and, in one embodiment, this data is provided to the game selector, along with a weighting factor for each priority that rates how much that priority should be emphasized relative to the other priorities.

For a given priority, each game's score on that priority is normalized according to the following equation:

$${y}_{i} = \frac{{x}_{i} - μ}{σ} \qquad EQUATION 1$$

where xᵢ is the raw score for a single game, μ is the arithmetic mean of the raw score for all games in the game set, and σ is the standard deviation of the raw score for all games in the game set.

The normalized scores for a given priority are then multiplied by the weight for that variable. This process is repeated for the variables in the priority list, and these normalized scores are then summed together as follows:

zᵢ=Σⱼ₌₁^{k}wⱼyᵢ EQUATION 2:

where wⱼ is the weighting factor for priority j, and yᵢ is the output of Equation 1.

The result of Equation 2 is normalized again via Equation 1, and then scaled by the following logistic function:

$$y = \frac{1}{1 + {e}^{- gx}} \qquad EQUATION 3$$

where g is a global gain parameter that controls how strongly the game selector 625 tries to maximize showing games with the highest scores versus choosing randomly. Finally, the resulting values are divided by the sum for all games:

$${p}_{i} = \frac{{x}_{i}}{{\sum }_{j = 1}^{n} {x}_{j}} \qquad EQUATION 4$$

The output of this function returns a vector of probabilities whose sum is equal to one. The probability for games whose session introduction numbers are greater than or equal to the current session number are then set to zero, and the probability vector is renormalized again according to Equation 4. These probabilities are then reweighted by the following additional components before they are provided to the game selector 525 (FIG. 5).

C. Controlling for Deviations from Expected Behavior

In one embodiment, after calculating the initial probabilities from priorities and static game data in Step 605, the probability calculator 520 controls deviations from expected frequencies (Step 610). Specifically, as the training algorithm is probabilistic, it may be desirable to control how far a given user's game recommendations deviate over time from what would be expected on average across a large number of users with the same inputs. One way to control this deviation is to estimate the expected play counts from the probabilities calculated above. The expected play counts for each game can be estimated via the following equation:

$$E ( {c}_{i} ) = \frac{{p}_{i} ( s - {s}_{{0}_{i}} ) {\sum }_{i = 1}^{n} {c}_{i}}{s} \qquad EQUATION 5$$

Here, pᵢ is the baseline probability for game i as calculated above, s is the current session number, s₀_{ᵢ} is the session introduction number for game i, and Σᵢ₌₁ⁿcᵢ is the total numbers of gameplays across games in the game set. So, for example, if the baseline probability of choosing Memory Matrix is 0.05, the game was introduced on session 1, the user is on session 21, and the user has completed 100 games, the expected play count would be 5.

The expected count can be compared to the actual number of times the user has seen this game to obtain a deviation score:

dᵢ=E(cᵢ)−cᵢ EQUATION 6:

If the user has played Memory Matrix 3 times, then the deviation score dᵢ would equal 2. If the user has played Memory Matrix 7 times, dᵢ would equal −2. The deviations for each game are then normalized using Equation 1 and then transformed via the logistic function in Equation 3 (with a separate gain parameter), and converted to probabilities via Equation 4. The separate gain parameter provides flexible control over how much a given user's training trajectory over time is allowed to deviate from the expected probabilities given by the training priorities and the user's preferences. The resulting values are then multiplied by the probabilities calculated in the previous section and divided by their sum (Equation 4) in order to obtain a new set of probabilities.

D. Encourage Local Consistency

As consistently training on a task over a reasonably short period of time tends to result in a faster rate of improvement on that task, the algorithm takes another step to encourage that there is some local consistency in the training experience (Step 615). The probability calculator 520 can accomplish this by tracking the running count of the number of times a game has been shown recently. This value can be calculated as follows. If a game is shown in a given training session, the running count is incremented by one (1). If the game is not shown, the count is reset to zero (0). This running count is then used as an additional multiplier for the probabilities calculated in the previous section. There are many functions that could ensure some amount of local consistency. One possible function would be the following:
If running count=0 (game did not appear in previous session):
   Multiply probability from above by 1

If running count=1 (game appeared in previous session, but not two sessions ago):
Multiply probability from above by 2
If running count=2 (game appeared in the previous two sessions):
   Multiply probability from above by 1
If running count>2:
   Multiply probability from above by 0

This example makes it more likely that a game would appear in session N if it appeared in session N−1, and would allow it to appear if it appeared both in sessions N−1 and N−2, but ensure that the game would not appear more than three sessions in a row. The resulting values are then divided by the total for the games (Equation 4) again to create the final set of game probabilities 620. These probabilities are then combined with the game data and given as input to the game selector 525 (FIG. 5), along with the aforementioned game-game matrix.

E. Game Selector

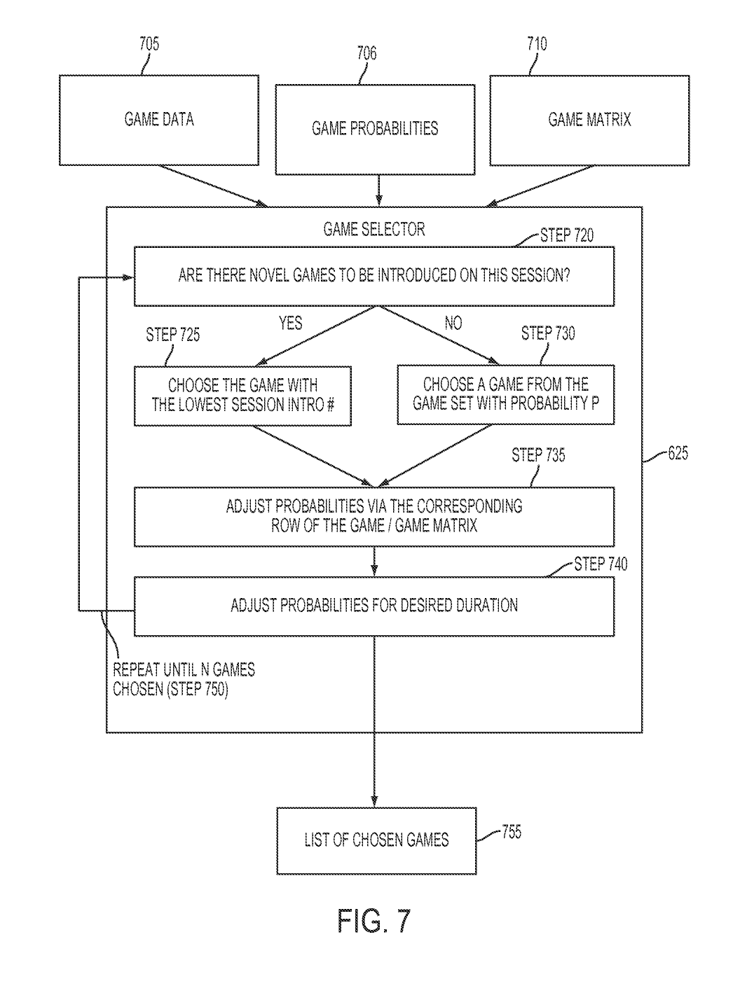

FIG. 7 shows a flow diagram of game selector 625. In one embodiment, in addition to relying on the probabilities, it may also be desirable to introduce new games gradually, in order to provide continuing novelty to the training experience, and to ensure that training becomes more challenging over time. The game selector 625 can accomplish these goals by using the session introduction number described above. This variable denotes the first training session on which a particular game should appear.

In one embodiment, the game selector 625 considers a game as a novel game to introduce on the current session (Step 720) if the current session number is greater than or equal to the session introduction number for this game (Step 725), and the play count for this game is equal to a predetermined play count number (e.g., zero). In the case that there is more than one game fitting these criteria, games can be selected in increasing order of the earliest session introduction number. This has the effect of prioritizes games that should have been introduced on an earlier session. In addition, one might wish to limit the number of novel games to introduce, for example, by limiting this number to two.

If there are no new games to introduce on this session, or if the game selector 625 has already selected a predetermined number (e.g., all) of such games, a game can be chosen probabilistically using the output 620 of the probability calculator (shown as game data 705 and game probabilities 706 and in FIG. 7 Step 730). After a game has been selected, either through the novel game selection process or the probabilistic selection process, in one embodiment the game probabilities are updated (Step 735), such as to accomplish the following two goals:
(1) Disallow and/or reduce the probability that certain games appear together, and/or
(2) Keep the expected length of the session (in minutes) close to the average session length

Game matrix 710 is an input provided to the game selector 525. The game matrix 710 can control which games appear together. For a game set containing N games, this matrix 710 contains N rows and N columns corresponding to the combination of each game in the game set with each other game in the game set. A value of 1 can imply that the game corresponding to the row and the game corresponding to the column are allowed to appear together. A value of 0 can imply that the game corresponding to the row and the game corresponding to the column should not appear together. Intermediate values can correspond to a weakening of the probability that selecting game 1 should make it less likely that the game selector will later select game 2, without ruling it out altogether. Setting the diagonal cells of this matrix to zero (0) can ensure that the same game cannot be chosen twice in the same session. In one embodiment, the matrix is also generally symmetric across this diagonal, since the probability of choosing game j given that the selector has chosen game i should in general be equal to the probability of choosing game i given that the selector has chosen game j.

After a game is selected, the probabilities for the games are multiplied by their corresponding values on the row associated with the currently selected game, as follows:

pⱼ=pⱼG_{i,j} EQUATION 7:

where pⱼ is the probability for game j, i is the chosen game, and G_{i,j} is the corresponding value in the game matrix 710. These values are then divided by their sum (Equation 4) to obtain probabilities again.

The average game length can be calculated based on an estimate of the average length in time of each game (possibly derived from an existing database of gameplays) multiplied by the baseline probabilities provided as input to the game selector:

$$E ( t ) = \frac{{\sum }_{i = 1}^{n} {t}_{i}}{n} \qquad EQUATION 8$$

where tᵢ is the estimated length in minutes of game i, and n is the number of games in the game set.

After a game is chosen by the game selector 625, the current difference between the average game length in the current session and the average expected game length is calculated as:

t_{dev}=E(t)−Σᵢ₌₁^{k}tᵢ EQUATION 9:

where k is the number of games that have been selected thus far. If E(t) is equal to 3 minutes, and two games have been chosen, with lengths 3 minutes and 5 minutes, then t_{dev} would be equal to −1. If the games had length 3 minutes and 1 minute, t_{dev} would be equal to 1.

The estimated lengths for each game are multiplied by this deviation, and passed through the logistic function in Equation 3, with a gain equal to the overall gain parameter divided by the number of games left to select. For example, if the overall gain parameter is equal to 1, the number of games to be selected in the current session is 5, and 2 games have been selected so far, then the gain parameter in Equation 3 will be ⅓. Modulating the gain parameter in this way makes the game selector 625 value keeping the session duration close to the desired duration more as it gets closer to having selected all games in the session (Step 740).

If during the course of the game selection process the number of games with non-zero probabilities falls below the number of games required to create a complete training session, the game selection process can fall back on probabilities that were calculated earlier. In one embodiment, if this situation occurred, the game selector could first recalculate the initial probabilities rejecting games that have already been chosen and games that have a session introduction number greater than the current session number, while ignoring the game/game matrix. If there are still not enough games remaining to complete the session, the game selector could recalculate the probabilities according to Equation 4 and exclude games that have already been selected, If there are still not enough games remaining to complete the session, the game selector could reuse the initial probabilities calculated in Equation 4.

The training system could also provide the user with the ability to replace a game in his or her training session. In one embodiment, the user would be presented with a “swap game” option immediately before beginning training on each game selected by the above process. Upon clicking this option, the same game selection process would be used to generate a number of additional games excluding those games that were originally selected for the training session.

In one embodiment, the output of this function is divided by its sum to obtain probabilities (Equation 4), multiplied by the probabilities calculated in the above section, and then divided by the sum again (Equation 4) to obtain probabilities used to select the next game. The game selector 625 repeats the process of choosing a game and updating the probabilities by the game matrix and session length until the desired number of games 755 has been selected (Step 750). The final list of selected games 755 can be randomly changed so that any potential dependencies of the selection algorithm are not present in the order in which games appear in the current session.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computing device comprising:
a processor;
a storage medium for tangibly storing thereon program logic for execution by the processor, the program logic comprising:
determining logic, executed by a probability calculator on the processor, for determining user data, priorities, and game data;
calculating logic, executed by the probability calculator, for calculating initial probabilities that a neurocognitive game will appear in a session, the session comprising neurocognitive games selected for presentation to a user, the calculating based on the user data, the priorities, and the game data;
communicating logic, executed by the probability calculator, for communicating to a game selector the initial probabilities, the game data, and a matrix controlling how likely a plurality of neurocognitive games will appear in the session; and
selecting logic, executed by the game selector, for selecting a set of neurocognitive games for the session, the selecting based on the initial probabilities, the game data, and the matrix.

2. The computing device of claim 1, wherein the determining logic for determining the priorities further comprises determining logic for determining priorities derived from the user's play history and information about each neurocognitive game in the games selected for presentation to the user.

3. The computing device of claim 2, wherein the determining logic for determining the priorities further comprises determining logic for determining popularity of the each neurocognitive game.

4. The computing device of claim 2, wherein the determining logic for determining the priorities further comprises determining logic for determining measures of previous performance on the neurocognitive game by the user.

5. The computing device of claim 1, wherein the determining logic for determining the priorities further comprises determining logic for determining measures of previous performance in a neurocognitive domain with which the game is associated.

6. The computing device of claim 1, wherein the communicating logic for communicating the initial probabilities, the game data, and the matrix further comprises communicating logic for communicating a weighting factor for each priority in the priorities.

7. A computing device comprising:
a processor;
a storage medium for tangibly storing thereon program logic for execution by the processor, the program logic comprising:
(a) receiving logic, executed by a game selector on a computing device, for receiving game data with game probabilities and a game matrix;
(b) determining logic, executed by the game selector, for determining whether there are novel games to be introduced in a session;
(c) selecting logic, executed by the game selector, for:
(i) if there are novel games to be introduced, selecting a game with a lowest session introduction number;
(ii) if there are no novel games to be introduced, selecting a game with a predetermined probability;
(d) adjusting logic, executed by the game selector, for adjusting probabilities via the game matrix; and
(e) repeating logic, executed by the game selector, for repeating steps (b)-(d) until a predetermined number of games have been selected;

8. The computing device of claim 7, further comprising providing logic executed by the game selector for providing one or more of the predetermined number of games to a user in the session.

9. The computing device of claim 7, wherein the determining logic for determining whether there are novel games to be introduced in a session further comprises determining logic for determining if a current session number of the game is greater than or equal to the session introduction number of the game and a play count for the game is equal to a predetermined play count number.

10. The computing device of claim 7, further comprising adjusting logic executed by the game selector for adjusting probabilities for a predetermined duration.

11. A non-transitory computer readable storage medium tangibly storing computer program instructions capable of being executed by a computer processor, the computer program instructions defining the steps of:
determining, by a probability calculator executing on the computer processor, user data, priorities, and game data;
calculating, by the probability calculator, initial probabilities that a neurocognitive game will appear in a session, the session comprising neurocognitive games selected for presentation to a user, the calculating based on the user data, the priorities, and the game data;
communicating, by the probability calculator to a game selector, the initial probabilities, the game data, and a matrix controlling how likely a plurality of neurocognitive games will appear in the session; and
selecting, by the game selector, a set of neurocognitive games for the session, the selecting based on the initial probabilities, the game data, and the matrix.

12. A non-transitory computer readable storage medium tangibly storing computer program instructions capable of being executed by a computer processor, the computer program instructions defining the steps of:
(a) receiving, by a game selector executing on the computer processor, game data with game probabilities and a game matrix;
(b) determining, by the game selector, whether there are novel games to be introduced in a session;
(c) if there are novel games to be introduced, selecting, by the game selector, a game with a lowest session introduction number;
(d) if there are no novel games to be introduced, selecting, by the game selector, a game with a predetermined probability;
(e) adjusting, by the game selector, probabilities via the game matrix; and
(f) repeating, by the game selector, steps (b)-(e) until a predetermined number of games have been selected.

13. A method comprising:
determining, by a probability calculator executing on a computing device, user data, priorities, and game data;
calculating, by the probability calculator, initial probabilities that a neurocognitive game will appear in a session, the session comprising neurocognitive games selected for presentation to a user, the calculating based on the user data, the priorities, and the game data;
communicating, by the probability calculator to a game selector, the initial probabilities, the game data, and a matrix controlling how likely a plurality of neurocognitive games will appear in the session; and
selecting, by the game selector, a set of neurocognitive games for the session, the selecting based on the initial probabilities, the game data, and the matrix.

14. The method of claim 13, wherein the determining of the priorities further comprises determining priorities derived from the user's play history and information about each neurocognitive game in the games selected for presentation to the user.

15. The method of claim 14, wherein the determining of the priorities further comprises determining popularity of the each neurocognitive game.

16. The method of claim 14, wherein the determining of the priorities further comprises determining how the each neurocognitive game relates to a ranking associated with the user of neurocognitive domains.

17. The method of claim 13, wherein the determining of the priorities further comprises determining measures of previous performance on the neurocognitive game by the user.

18. The method of claim 13, wherein the determining of the priorities further comprises determining measures of previous performance in a neurocognitive domain with which the game is associated.

19. The method of claim 13, wherein the communicating of the initial probabilities, the game data, and the matrix further comprises communicating a weighting factor for each priority in the priorities.

20. The method of claim 13, wherein the calculating of the initial probabilities further comprises controlling deviations from expected frequencies.

21. The method of claim 13, wherein the calculating of the initial probabilities further comprises adjusting the initial probabilities for local consistency.

22. The method of claim 13, wherein the calculating of the initial probabilities further comprises, for a priority in the priorities, determining:
$${y}_{i} = \frac{{x}_{i} - μ}{σ}$$
where xᵢ is a raw score for a game, μ is an arithmetic mean of the raw score for the games in the set, and σ is a standard deviation of the raw score for the games in the set.

23. A method comprising:
(a) receiving, by a game selector executing on a computing device, game data with game probabilities and a game matrix;
(b) determining, by the game selector, whether there are novel games to be introduced in a session;
(c) if there are novel games to be introduced, selecting, by the game selector, a game with a lowest session introduction number;
(d) if there are no novel games to be introduced, selecting, by the game selector, a game with a predetermined probability;
(e) adjusting, by the game selector, probabilities via the game matrix; and
(f) repeating, by the game selector, steps (b)-(e) until a predetermined number of games have been selected.

24. The method of claim 23, further comprising providing one or more of the predetermined number of games to a user in the session.

25. The method of claim 23, wherein the determining of whether there are novel games to be introduced in a session further comprises determining if a current session number of the game is greater than or equal to the session introduction number of the game and a play count for the game is equal to a predetermined play count number.

26. The method of claim 23, further comprising adjusting, by the game selector, probabilities for a predetermined duration.
